(19) United States
(12) Patent Application Publication
(10) Pub. No.: US 2008/0285099 A1
(43) Pub. Date: Nov. 20, 2008

(54) Method and apparatus for forming multi-dimensional colloidal structures using holographic optical tweezers

(75) Inventors: Christopher Knutson, Chicago, IL (US); Joseph Plewa, Park Ridge, IL (US)

Correspondence Address: AKERMAN SENTERFITT, 801 PENNSYLVANIA AVENUE N.W., SUITE 600, WASHINGTON, DC, 20004, US

(73) Assignee: Arryx, Inc., Chicago, IL (US)

(21) Appl. No.: 11/484,598

(22) Filed: Jul. 12, 2006

Related U.S. Application Data
(60) Provisional application No. 60/697,949, filed on Jul. 12, 2005.

(51) Int. Cl. G02B 5/32

(52) U.S. Cl. 359/15

(57) ABSTRACT

Holographic optical tweezers are used to position charge stabilized colloidal particles within a flow cell. Once the particles are positioned, fixation is accomplished by pumping an electrolyte solution or pH adjusted solution (or a combination of the two) into the sample cell. In the former, the Debye length is reduced and aggregation caused by the van der Waals attraction takes place. In the latter, the surface charge density of the suspension is reduced and aggregation caused by the van der Waals attraction takes place. This technique can be applied multiple times, and allows for the formation of two and three dimensional structures composed of multi-colloid types to be formed on or away from a substrate. The technique relies upon forces acting on virtually all colloidal dispersions making it applicable to a wide variety of colloid types and compositions, such as formation of photonic crystals, colloidal electronics, and bioengineered materials.

### CROSS-REFERENCE TO RELATED APPLICATIONS

The present invention claims priority from U.S. Provisional Patent Application No. 60/697,949, filed Jul. 12, 2005, the contents of which are herein incorporated by reference in their entirety.

### BACKGROUND OF THE INVENTION

1. Field of the Invention

The present invention relates to a method and apparatus for forming permanent multi-dimensional structures from colloidal particles using holographic optical trapping (HOT).

2. Description of the Related Art

Structures formed from colloidal particles hold great promise for applications that reach across a wide variety of fields. These structures typically consist of particles with diameters of a few nanometers to a few microns and can be formed from a wide variety of materials with specific chemical morphology. This tunability gives researchers the capability to form devices that can exhibit interesting optical, electronic, and magnetic behavior.

Typical formations of two and three dimensional colloidal structures relies on self-assembly driven techniques such as template-assisted self-assembly or various field-driven techniques. Such techniques generally produce large scale structures in a short amount of time but lack the capability to form long-range defect-free structures. In addition, forming complex yet regular colloidal crystals composed of two or more colloid types with different diameters and/or compositions is quite difficult.

Recently, researchers have demonstrated that structures formed from colloidal particles can be formed by positioning particles in a polymer gel solution with multiple optical traps. Once the gel sets, the particles remain fixed in place. This technique can produce three-dimensional structures but requires that the structure be formed in a gel matrix. Additionally, other researchers have demonstrated that relatively large two-dimensional structures could be formed by positioning charged colloidal particles on an oppositely charged substrate with optical traps generated by an acousto-optical deflector system. These structures could also be removed from solution with the aid of critical point drying. This technique has great potential for the formation of devices that rely on precisely positioned colloidal particles. However, the technique is limited to the formation of two-dimensional colloidal structures on a substrate. In many cases, true multi-layer colloidal structures are desirable for use in applications for photonic crystals, colloidal electronics, and bioengineered materials.

### SUMMARY OF THE INVENTION

The present invention includes a technique that allows for two and three dimensional structures to be formed on a substrate or in solution from charge-stabilized colloidal particles using holographic optical trapping (HOT). The use of HOT allows relatively large numbers of particles composed of a variety of substances to be precisely positioned without the introduction of foreign objects into a sample cell. Additionally, this assembly technique relies on altering interaction potentials that exist in almost all colloidal suspensions, namely the Coulomb and van der Waals interactions. This makes the technique widely applicable to many systems.

Further, the present invention includes a technique that can be used to build colloidal structures capable of withstanding the forces associated with removing the structure from solution without the aid of critical point drying. This technique opens a new route to form large two and three dimensional colloidal structures composed of a wide variety of materials that are capable of being removed from solution without using critical point drying.

Finally, the technique can be cycled in the sense that the entire process can be repeated several times which enables structures to be formed from multiple colloid types. Once the first assembly is performed, that initial structure remains intact and can then be used in subsequent assembly steps allowing for very complex materials to be fabricated from multiple material types.

In the present invention, holographic optical tweezers (HOT) are used to position charge stabilized colloidal particles within a flow cell. Once the particles are in the desired location an electrolyte solution is pumped into the cell which reduces the Debye length and induces aggregation caused by the van der Waals attraction. The present invention allows for the formation of three dimensional structures both on and away from the substrate, that can be removed from solution without the aid of critical point drying.

In one embodiment consistent with the present invention, a method of assembling a multi-dimensional colloidal structure includes: filling a sample chamber with a stable suspension of charge-stabilized colloidal particles; trapping the particles with holographic optical tweezers; destabilizing the suspension by flowing at least one of an electrolyte solution and a pH-adjusted solution into the sample chamber; and bringing the trapped particles into contact with each other by one of placing individual particles on a surface of the substrate using holographic optical trapping, and by placing individual particles in contact with neighboring particles to form a multi-dimensional structure.

Further, in various embodiments consistent with the present invention, the colloid is a monodisperse substance, a biological material such as a cell or a vesicle, a semiconductor material, and a photonic bandgap crystal.

Still further, in another embodiment consistent with the present invention, the colloid is a material that is capable of producing an attractive van der Waals interaction with one of each other and the substrate.

Still further, in yet another embodiment consistent with the present invention, the suspension includes colloidal particles from two or more colloidal species.

Still further, in yet another embodiment consistent with the present invention, the multi-dimensional structure is formed by aggregating only a portion of the colloidal particles based upon a material and dimensional characteristics of the colloidal particles.

Still further, in yet another embodiment consistent with the present invention, the multi-dimensional colloidal structure is an array, and the array is formed by combining the particles into a two-dimensional square lattice pattern.

Still further, in yet another embodiment consistent with the present invention, a three-dimensional crystal is formed from a plurality of arrays, and suspended above the substrate.

Still further, in yet another embodiment consistent with the present invention, the crystal is rotated relative to the substrate to achieve a desired orientation before depositing the crystal on the substrate.

Still further, in yet another embodiment consistent with the present invention, an initial layer of the particles is deposited as a lattice pattern on the substrate by reducing a focal length of a collection of the optical traps until all of the particles in the initial layer are in contact with the substrate.

Still further, in yet another embodiment consistent with the present invention, additional individual particles are positioned within the lattice pattern to form a second layer of particles, as a three-dimensional colloidal structure.

Still further, in yet another embodiment consistent with the present invention, the particles in the initial layer and in the second layer are of different sizes.

Still further, in yet another embodiment consistent with the present invention, the multi-dimensional structure is removed from the electrolyte solution without critical point drying.

Still further, in yet another embodiment consistent with the present invention, the sample chamber is flushed with a solution that increases an electrostatic repulsion of the suspension without removing the multi-dimensional structure; and another stable suspension of charge-stabilized colloidal particles is introduced into the sample chamber.

Still further, in yet another embodiment consistent with the present invention, the multi-dimensional structure is flushed from the sample cell through collection of the solution.

Still further, in yet another embodiment consistent with the present invention, an apparatus for assembling a multi-colloidal structure includes a holographic optical tweezers which forms optical traps; a sample cell including: a substrate; a sample chamber disposed on the substrate; an input tube into the sample chamber; an output tube from the sample chamber; a stable suspension of charge-stabilized colloidal particles; and an electrolyte introduced into the sample chamber via the input tube; wherein the particles are trapped by the holographic optical tweezers to form the multi-dimensional structure.

Still further, in yet another embodiment consistent with the present invention, the apparatus further includes a syringe through which the electrolyte is pumped by a syringe pump.

Still further, in yet another embodiment consistent with the present invention, an apparatus for assembling a multi-colloidal structure includes a holographic optical tweezers which forms optical traps; a sample cell including: a substrate; a sample chamber disposed on the substrate; an input tube into the sample chamber; an output tube from the sample chamber; a stable suspension of charge-stabilized colloidal particles; and a pH adjusted solution introduced to the sample chamber, adjusted to one of an acidic and basic level depending on a charge species of the colloidal particles; wherein the particles are trapped by the holographic optical tweezers to form a multi-dimensional structure.

Finally, in yet another embodiment consistent with the present invention, an apparatus for assembling a multi-colloidal structure includes a holographic optical tweezers which forms optical traps; a sample cell including: a substrate; a sample chamber disposed on the substrate; an input tube into the sample chamber; an output tube from the sample chamber; a stable suspension of charge-stabilized colloidal particles; an electrolyte introduced into the sample chamber via the input tube; and a pH adjusted solution inputted into the sample chamber, adjusted to one of an acidic and basic level depending on a charge species of the colloidal particles; wherein the particles are trapped by the holographic optical tweezers to form a multi-dimensional structure.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

The following drawings illustrate the invention, where:

FIG. 1 is a perspective view of a sample cell according to one embodiment consistent with the present invention.

FIG. 2(a) is a brightfield image of a plurality of particles which are trapped and separated in the sample cell of FIG. 1, according to one embodiment consistent with the present invention.

FIG. 2(b) is a brightfield image of the particles of FIG. 2(a), being combined into a two-dimensional (2D) simple square lattice pattern, according to one embodiment consistent with the present invention.

FIG. 2(c) is a brightfield image of the particles of FIG. 2(b), formed into three 3×1 arrays until a 3×3 crystal is formed, according to one embodiment consistent with the present invention.

FIG. 2(d) is a brightfield image of the crystal of FIG. 2(c), which is rotated 90° above the substrate about an axis parallel to the coverslip, according to one embodiment consistent with the present invention.

FIG. 2(e) is a brightfield image of the crystal of FIG. 2(d), rotated again by 450 before being deposited on the substrate, to produce a 3×3 crystal, according to one embodiment consistent with the present invention.

FIG. 3 is a plot of the interaction potential for a spherical 2.40 μm silica particle and flat glass substrate as a function of separation under prepared low electrolyte conditions.

FIG. 4 is a plot of the interaction potential for a spherical 2.40 μm silica particle and flat glass substrate as a function of separation at high electrolyte conditions.

FIG. 5 is a brightfield image of a three-dimensional, two layer colloidal crystal of silica particles formed on the glass coverslip substrate, according to one embodiment consistent with the present invention.

FIG. 6(a) is a brightfield image of the complete colloidal crystal structure formed from two populations of differently sized silica spheres, according to one embodiment consistent with the present invention.

FIG. 6(b) is a brightfield image of the same structure as in FIG. 4(a) after the aqueous phase has been removed, according to one embodiment consistent with the present invention.

### DESCRIPTION OF THE INVENTION

The present invention relates to forming two and three dimensional structures on a substrate or in solution from charged stabilized colloidal particles using holographic optical trapping (HOT). HOT is described in U.S. Pat. No. 6,055,106 (Grier et al.), and in corresponding U.S. patent applications No. 10/735,395 (Gruber et al.), the contents of which are herein incorporated by reference in their entirety.

In the present invention, holographic optical traps are generated using a device such as the Arryx Bioryx 200™ system utilizing, for example, a 532 nm continuous wave laser (such as a Spectra Physics Millennia V) on an inverted microscope (such as a Nikon TE-200).

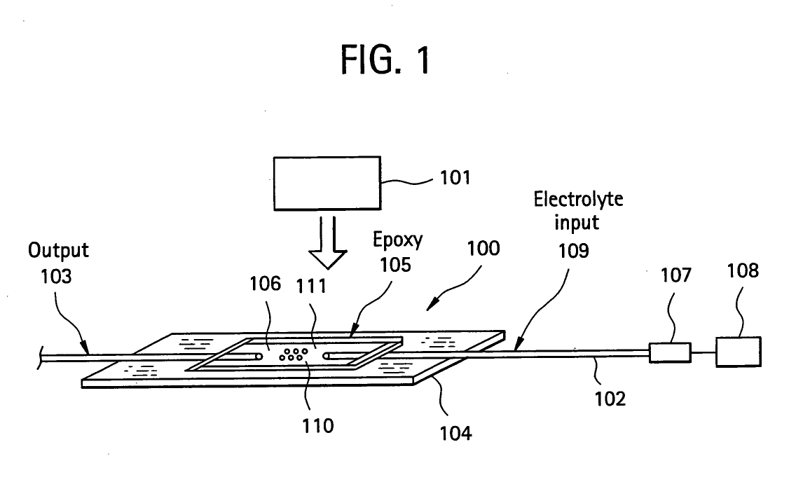

FIG. 1 is an illustration of the assembly sample cell 100 used in the present invention. A 60× high numerical aperture (n.a.=1.4) oil immersion objective, for example, was used in the HOT system 101. The flow cell 100 was created by affixing the input flow tube 102 and output flow tube 103 (for example, Tygon tubing, with an inner diameter (ID)=0.40″, and an outer diameter (OD)=0.07″), to a 50 mm by 22 mm #1 coverslip 104, for example, with an epoxy gel 105 (i.e., Devcon Five Minute Epoxy Gel), and then placing a standard glass slide 106 on top of the epoxy well 106. The electrolyte input tube 102 was connected to a 3 mL syringe 107, for example, and a syringe pump 108 (i.e., a WPI SP2001), which was used to control the flow rate of the electrolyte solution 109 into the sample cell 100.

Specifically, the assembly process began by filling the sample chamber 111 of the sample cell 100 with a charge-stabilized colloidal suspension—i.e., a solid phase consisting of particles or cells with a characteristic size of tens of microns to one nanometer, that when dispersed in a continuous phase, acquire a surface charge. Examples of a colloid include, but are not limited to, cells, vesicles, quantum dots, semiconductor dots, etc.

In this experiment, a commercially available monodisperse silica colloid (such as Bangs Laboratories #SS04N/5569) with a diameter of 2.34 μm, was used as an example. Once the sample chamber 111 was filled, the sample cell 100 was sealed with epoxy 105. The colloid was used as-is, without any surface modification and dispersed in filtered water (such as Barnstead Nanopure—pH adjusted to 7.0 with 0.05 M NaOH) to produce a concentration of approximately 1×10⁶ particles/mL, for example.

The sample cell 100 was placed on the microscope stage (not shown) and the particles 110 were allowed to sediment to the coverslip surface 104. This concentration produced a two-dimensional packing fraction of approximately 2% that achieved an excellent balance between availability of free particles 110 and open space to form structures.

Particles 110 were then trapped with the holographic optical tweezers 101 and held in place away from each other and the walls of the chamber 111 of the flow cell 100. Typically 10 to 50 particles 110 were acquired in one assembly step with an average single trap power of 18 to 90 mW, for example. However, one of ordinary skill in the art would know that the power needed for trapping will vary with the size and type of particles, etc. The trap powers used in the example, ensured that trapped particles 110 could withstand viscous drag forces associated with introducing the electrolyte solution 109 into the cell 100.

Once the particles 110 were trapped, a 0.2 M NaCl (such as Sigma Aldrich #S-7655) solution 109, for example, was flowed into the sample cell 100. Although diffusion can produce the desired effect by simply introducing electrolyte 109 into the input syringe 107, flowing electrolyte solution 109 into the sample cell 100 ensured that the entire cell volume consisted of the same concentration of electrolyte 109 as the source 107. A flow rate of approximately 0.1 mL/min was used, for example, depending on the number of particles 110 trapped. The electrolyte 109 flow was at one to two times the sample cell volume into the cell 100. However, one of ordinary skill in the art would know what electrolyte and at what flow rate and concentration to use with the particular colloid chosen.

A few untrapped particles 110 were left in the field of view of the sample chamber 111 to observe the aggregation process. Once the thermal motion of these indicator particles 110 stopped, trapped particles 110 were brought into contact using HOT, with the coverslip 104 or with each other by either placing individual particles 110 on the surface of the coverslip 104, or in contact with neighboring particles 110. Accordingly, these particles 110 could be assembled into multi-dimensional structures.

Additionally, entire groups of particles 110 could be brought into contact with the coverslip (substrate) 104 by adjusting the focal length of entire groups of the trapped particles 110 using the HOT 101. All particles 110 aggregated within approximately four seconds of being brought into contact with each other or the substrate 104.

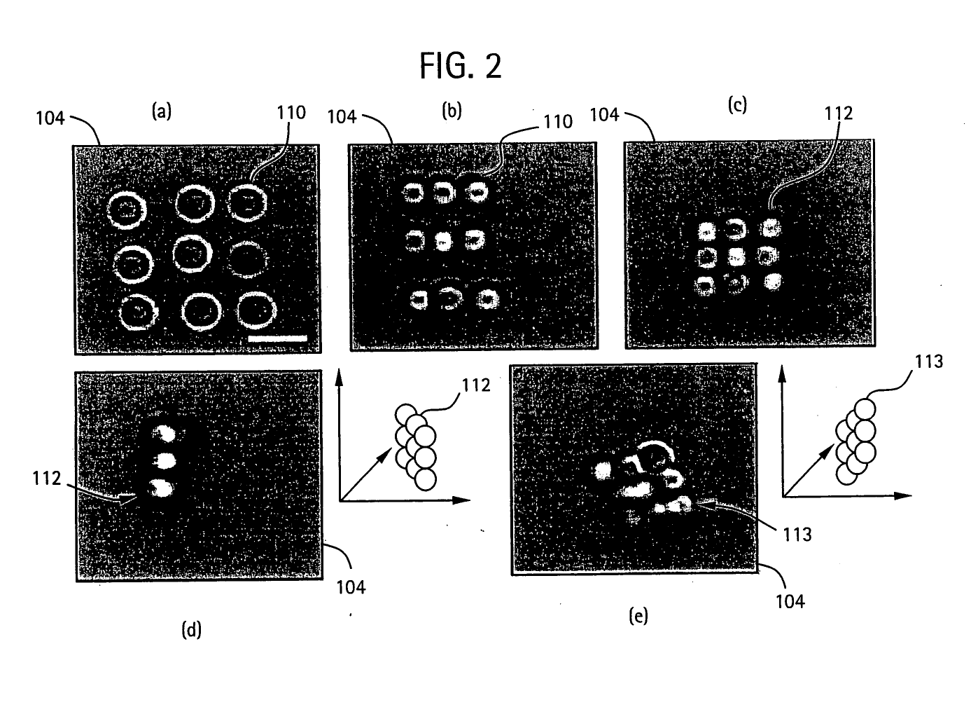

FIG. 2 is a collection of images illustrating the assembly process of a 3×3 colloidal crystal in free space using HOT 101. The same reference numerals in this and subsequent Figures, refer to the same elements described above.

In the example shown in FIG. 2(a), nine particles 110 were trapped and separated and held apart from the glass coverslip 104 and each other. The particles 110 were separated from neighboring surfaces by approximately 2 μm, for example. A 0.2 M NaCl electrolyte solution 109, for example, was then introduced into the sample cell 100, and the particles 110 were combined into a two-dimensional (2D) simple square lattice pattern (see FIG. 2(b)), for example, to form three 3×1 arrays 112 (see FIG. 2(c)), until a 3×3 crystal 112 was formed and suspended above the substrate by approximately 10 μm. Thus, a structure in three dimensions could be assembled.

In FIG. 2(d), for example, the crystal 112 was rotated 90° above the substrate about an axis parallel to the coverslip 104 using four optical traps, and then rotated again by 450 before being deposited on the substrate 104. However, one of ordinary skill in the art would know that the crystal 112 could be rotated by any degree to show manipulation in three dimensions.

In this case only one particle 110 was in contact with the coverslip 104 surface. Tweezing with single or multiple traps with a net power of approximately 1 W had no clear effect on the structure 112 once it was positioned on the glass substrate 104.

In FIG. 2(e) the structure 112 was rotated once more by changing the focal length of three optical traps, and deposited on the substrate 104, for example, to produce a 3×3 crystal 113 in a diamond-like orientation. No optical traps were present in the final image. The scale bar is 5 μm.

Thus, an assembled three dimensional structure was obtained.

This behavior described above, can be understood with the celebrated DLVO theory of colloidal stability. Under the initial prepared conditions, the silica particles 110 and the glass surfaces 104 develop a negative surface charge principally caused by the disassociation of terminal silanol groups. At low electrolyte 109 concentrations and pH higher than the isoelectric point of silica (of the particles 110) this surface charge prevents particle flocculation and aggregation to the glass surfaces 104. This allows one to use HOT to trap particles for use in subsequent assembly. One of ordinary skill in the art would know that this behavior would be shown if particles made from other than silica, were used.

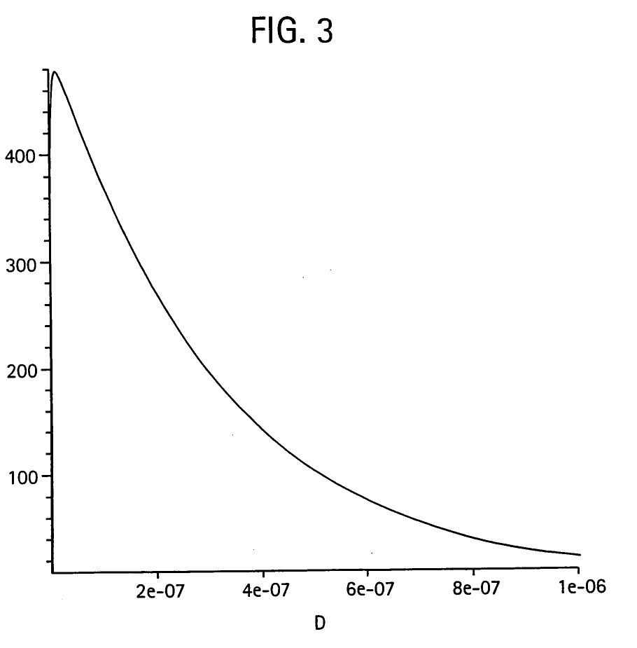

FIG. 3 is a plot of the interaction potential for a spherical 2.40 μm silica particle (for example) and flat glass substrate as a function of separation. The y axis is energy (units of k_{b}T at 300 K) and the x axis is sphere/substrate separation distance, D, in meters. The plot shows that the interaction between these two surfaces is strongly repulsive at distances greater than 1 nm—which renders the suspensions stable. Under these conditions, the Debye length is on the order of 2 μm. However, once an electrolyte 109 is introduced into the sample cell 101, the Debye length decreases as surface charge is screened by ions in solution 109 which allows particles, such as the silica 1.10 of this example, to approach like-charged surfaces within small separations—at which point the attractive van der Waals interaction can dominate the interaction potential.

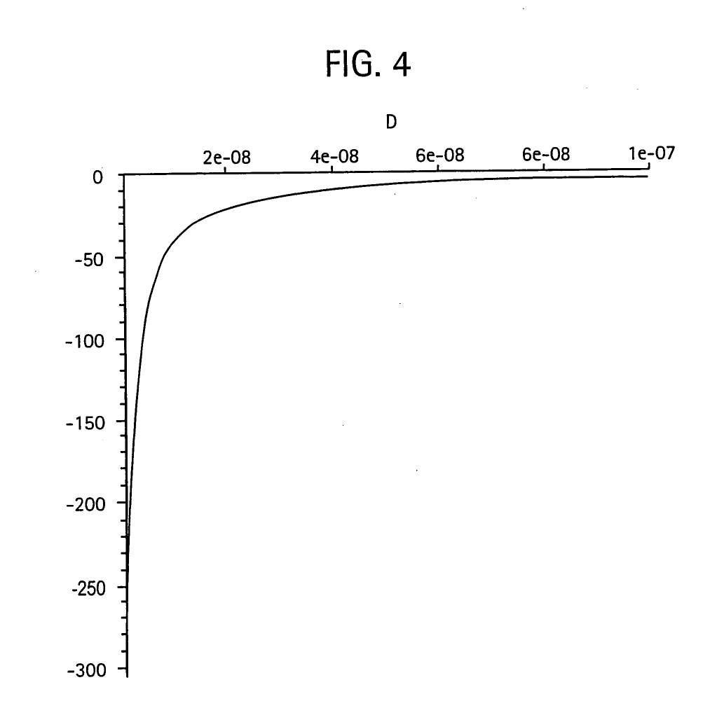

FIG. 4 is a plot of the interaction potential as a function of sphere/substrate separation once the electrolyte 109 has been flowed into the sample cell 101. This figure shows that the repulsive barrier existing in FIG. 3 has been completely diminished to produce a purely attractive interaction. Thus, at high electrolyte concentrations the particles 110 irreversibly aggregate. With a 0.2 M concentration of a 1:1 electrolyte 109, the Debye length is calculated to be 0.68 nm in this example.

In this scenario, the electrolyte concentration is sufficiently large to completely suppress the repulsive electrostatic contribution to the interaction potential. An additional embodiment of this invention is to precisely tailor the electrolyte concentration such that without an additional attractive potential the aggregation rates are minimal. This concentration depends strongly on the properties of the suspension and substrate. However, when tuned accordingly, the suspension could be made to remain quasi-stable until the additional potential of an optical trap acts on a particle. In this way, a particle could remain largely unbound in solution until a trap applies sufficient force to lock the particle in place.

An alternative embodiment of this invention involves changing pH instead of electrolyte concentration to control the surface charge of the colloidal suspension and substrate 104 within the sample cell 100. The level of surface ionization—and therefore surface charge—depends on the pH of the continuous phase. By adjusting the pH (to an acidic or basic level depending on the charge species) the magnitude of the repulsive interaction can be reduced such that even at low electrolyte concentrations where the Debye length is large, the repulsive electrostatic barrier is not large enough to prevent aggregation. Therefore this same technique of introducing a destabilizing agent into a sample cell 100 containing a HOT manipulated colloidal suspension assembled into a specific configuration described in the earlier embodiments can be accomplished by tuning the sample pH.

Each of these methods, (adjusting electrolyte concentration and/or pH) can also include suspensions consisting of two or more different colloidal species. As the rate of aggregation in either scenario (adjusting electrolyte concentration and/or pH) depends strongly upon the material and dimensional characteristics of the colloid, the conditions of the sample cell 100 could be made such that only one portion of the population would aggregate. Therefore the possibility exists for forming structures composed of multiple colloid types in the same sample cell in a step-wise manner.

Finally, since each of these methods do not permanently alter the chemical morphology of the suspension or chamber, the assembly process can be repeated multiple times. After the fixation process is accomplished by, introduction of electrolyte and/or pH adjusted solution, the sample cell 100 can be flushed with a solution that increases the electrostatic repulsion of the suspension. Since the attractive van der Waals potential is negligibly influenced by pH or electrolyte concentration it remains the dominate term in the interaction potential at the nanometer and sub-nanometer separations existing between the relevant surfaces. Therefore particles that are initially bound will remain in that state even though a fresh suspension will remain unbound. More or different colloids can be added to the sample cell and then the fixation process can be repeated until the desired final structure is assembled. This capability will allow for ultra-large and complex structures composed of multiple colloid species to formed. Theses structures can be used in application suspended in solution or attached to a substrate, as shown in FIG. 2(e), where the 3×3 crystal structures 112, 113 was obtained and deposited on a surface of a substrate 104.

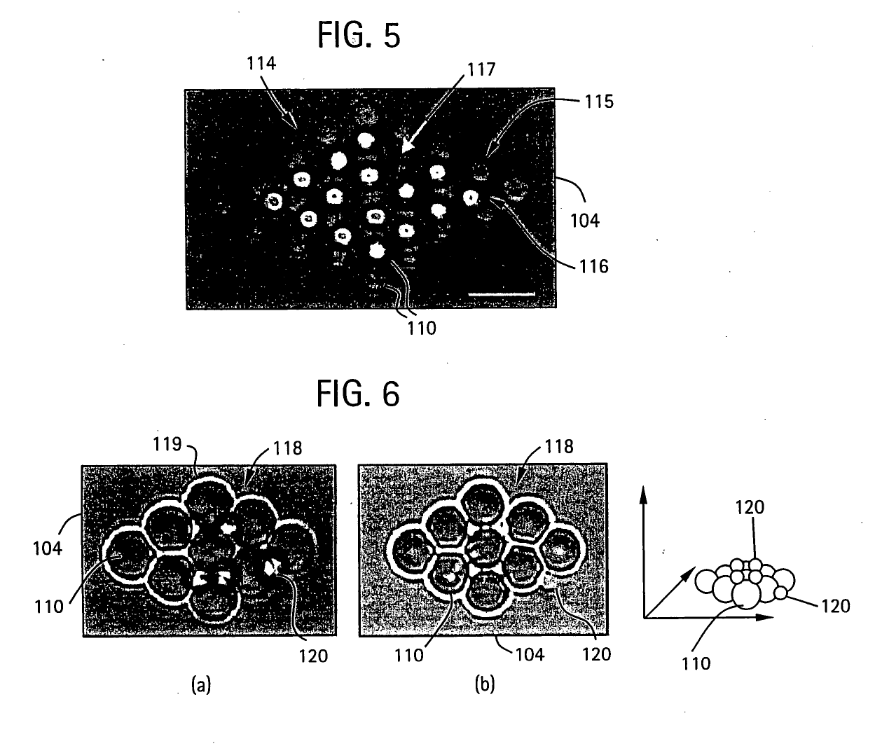

Several example multi-dimensional colloid structures made using this invention are described below. FIG. 5 shows a brightfield image of a larger (n=40), three-dimensional (3D), two layer colloidal crystal 114 composed of 2.34 μm silica particles 110, for example (although any type of charge-stabilized colloid that can be trapped can be used), which are formed on the glass coverslip substrate 104. In this case two layers 115, 116 of particles 110 which are optically trapped, are each arranged into a hexagonal pattern at different focal lengths and then a 0.2 M NaCl electrolyte solution, for example, is introduced.

The initial (first) layer 115 of particles 110 was deposited on the substrate 104 by reducing the focal length of the collection of the traps until all of the particles 110 in the first layer 115 were in contact with the coverslip 104. After this initial layer 115 was deposited, individual particles 110 were positioned, particle 110 by particle 110, within the lattice to form a second layer 116. After each particle 110 was deposited, the optical traps were removed from the structure 114. No optical traps are present in the final image. The arrow 117 indicates a defect. The scale bar is 5 μm.

Again, once the particles 110 were adhered to the substrate 104 or each other, using the fixation process described in this invention, subsequent additional optical tweezing had no apparent effect on the position of the particle 110 even at trap powers approaching 1 W, for example. This is to be expected since the energy of the applied optical trap (˜50 k_{b}T, for example) is much less than the typical van der Waals energy (˜hundreds to thousands of k_{b}T, for example) at nanometer and sub-nanometer length scales.

Additionally, this technique can be used to build a three-dimensional colloidal structure composed of two differently sized colloids.

FIG. 6(a) is a brightfield image of the complete structure 118 formed from two populations of differently sized silica spheres, used as an example. FIG. 4(a) shows a crystal 118 formed from 4.50 and 2.34 μm silica spheres (such as a Bangs Laboratories #SS059/4908, for example), which are dispersed together in the sample cell 100, trapped, and then organized as in previous experiments.

In this process, a 0.2 M NaCl solution, for example, was flowed into the sample cell 100 and a single layer 119 of 4.50 μm silica, for example, is then assembled into a two-dimensional hexagonal close packed lattice on the glass coverslip 104.

Then, five 2.34 μm silica particles 120 were then deposited over the first layer 119 of colloid. Specifically, an initial layer 119 of 4.50 μm silica, for example, is deposited in a HCP pattern, and 2.34 μm silica 120, for example, is deposited at the junction of three of the larger particles 110. In addition, one smaller particle 120 is placed at the junction of two particles 110.

The capability to build structures of two differently sized colloids, as described above, should be useful for the formation of complex photonic crystals. In addition, this technique should give rise to the capability of building structures composed of multiple colloid types where one colloid type may be dissolved by a series of washings. This method may open the possibility to form precisely positioned defects in photonic crystals for use as waveguides, etc., for example. Such photonic devices are predicted to display new and unique optical properties that may be useful for the telecommunications and electronics industries.

The assembled structures can be removed from the sample cell through collection of the suspended solution. Alternatively, the assembled structures can be brought into contact with the glass substrate using HOT and the fixation process to allow attachment in specific locations to the substrate. The assembled structure/substrate system can be removed from the sample cell for use in subsequent applications. Finally, many of these structures can be removed from solution without the aid of critical point drying.

To demonstrate this, one side of the chamber 111 (see FIG. 1) was sealed with hot glue rather than epoxy, for example. Once the structure 112 (see FIG. 2(c)) was formed, the hot glue was liquefied using a soldering iron and one side of the chamber 111 was exposed to atmosphere. The aqueous phase was allowed to evaporate from the sample cell 100. This process takes several hours depending on the proximity of the structure 112 to the open edge of the sample cell 100 and the thickness of the sample chamber 111.

FIG. 6(b) is a brightfield image of the same structure 118 as in FIG. 6(a) after the aqueous phase has been removed (i.e., allowed to evaporate). The arrow indicates a 2.34 μm particle 120, for example, that shifted position during the removal of the aqueous phase. The scale bar is 5 μm.

From the above, it can be seen that three-dimensional structures bound to a surface by a single connection, or crystals with large lattice constants typically undergo deformation upon drying. This observation is understandable given the low number of particle/particle and particle/substrate adhesion points and the large surface area of the structure 118.

One example of an application for this invention is in the construction of photonic bandgap crystals. These devices are made of materials with periodically varying dielectric constant. Similar to a semiconductor bandgap in which certain electronic energies are forbidden from propagating, photonic bandgap structures produce photon energies that are forbidden from propagating through the device. A regular array of colloidal particles can produce such a photonic bandgap. Precisely introduced defects consisting of alternate particles (with different index of refraction) or vacancies can therefore allow photons with specific energy to travel through the device in virtually any pattern.

Another application of this invention is in nano-printing for genome chips, for example.

Thus, the present invention includes a technique that allows two and three dimensional structures composed of multi-colloid types to be formed on or away from a substrate 104. The technique relies upon forces acting on virtually all colloidal dispersions making it widely applicable to a wide variety of colloid types and compositions. In addition, the structures can be removed from solution without the aid of critical point drying. This technique is useful in the formation of photonic crystals, colloidal electronics, and bioengineered materials.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of assembling a multi-dimensional colloidal structure comprising:
filling a sample chamber with a stable suspension of charge-stabilized colloidal particles;
trapping said particles with holographic optical tweezers;
destabilizing the suspension by flowing at least one of an electrolyte solution and a pH-adjusted solution into said sample chamber; and
bringing said trapped particles into contact with each other by one of placing individual particles on a surface of said substrate using holographic optical trapping, and by placing individual particles in contact with neighboring particles to form a multi-dimensional structure.

2. The method according to claim 1, wherein said colloid is a monodisperse substance.

3. The method according to claim 1, wherein said colloid is a biological material.

4. The method according to claim 3, wherein said biological material is one of a cell and a vesicle.

5. The method according to claim 1, wherein said colloid is a semiconductor material.

6. The method according to claim 1, wherein said colloid is a material that is capable of producing an attractive van der Waals interaction with one of each other and the substrate.

7. The method according to claim 1, wherein the substrate is a coverslip.

8. The method according to claim 1, Wherein said suspension includes colloidal particles from two or more colloidal species.

9. The method according to claim 8, further comprising:
aggregating only a portion of said colloidal particles based upon a material and dimensional characteristics of said colloidal particles.

10. The method according to claim 9, further comprising:
forming multi-dimensional structures of multiple colloidal particles.

11. The method according to claim 1, further comprising:
introducing electrolyte into said sample chamber via in input syringe.

12. The method according to claim 1, further comprising:
bringing groups of particles into contact with said substrate by adjusting a focal length of entire groups of trapped particles.

13. The method according to claim 1, wherein said multi-dimensional colloidal structure is an array, and said array is formed by combining said particles into a two-dimensional square lattice pattern.

14. The method according to claim 13, further comprising:
forming a three-dimensional crystal from a plurality of arrays, and suspending said crystal above said substrate.

15. The method according to claim 14, further comprising:
rotating said crystal relative to the substrate to achieve a desired orientation before depositing said crystal on said substrate.

16. The method according to claim 13, further comprising:
depositing an initial layer of the particles as said lattice pattern on said substrate by reducing a focal length of a collection of the optical traps until all of the particles in said initial layer are in contact with said substrate.

17. The method according to claim 16, further comprising:
positioning additional individual particles within said lattice pattern to form a second layer of particles, as a three-dimensional colloidal structure.

18. The method according to claim 10, wherein the particles in said initial layer and in said second layer are of different sizes.

19. The method according to claim 1, further comprising:
removing the multi-dimensional structure from said electrolyte solution without critical point drying.

20. The method according to claim 1, further comprising:
flushing said sample chamber with a solution that increases an electrostatic repulsion of the suspension without removing said multi-dimensional structure; and
introducing another stable suspension of charge-stabilized colloidal particles into said sample chamber.

21. The method according to claim 1, wherein said multi-dimensional structure is a photonic bandgap crystal.

22. The method according to claim 1, wherein said multi-dimensional structure is unbound in said solution until an optical trap is applied to fix said multi-dimensional structure in place.

23. The method according to claim 1, further comprising:
flushing said multi-dimensional structure from said sample cell through collection of said solution.

24. An apparatus for assembling a multi-colloidal structure comprising:
a holographic optical tweezers which forms optical traps;
a sample cell including:
a substrate;
a sample chamber disposed on said substrate;
an input tube into said sample chamber;
an output tube from said sample chamber;
a stable suspension of charge-stabilized colloidal particles; and
an electrolyte introduced into said sample chamber via said input tube;
wherein said particles are trapped by said holographic optical tweezers to form the multi-dimensional structure.

25. The apparatus according to claim 24, further comprising:
a syringe through which said electrolyte is pumped by a syringe pump.

26. The apparatus according to claim 25, wherein said syringe pump is used to control a flow rate of said electrolyte into said sample chamber.

27. The apparatus according to claim 24, wherein said colloid is a monodisperse substance.

28. The apparatus according to claim 24, wherein said colloid is a biological material.

29. The apparatus according to claim 24, wherein said biological material is one of a cell and a vesicle.

30. The apparatus according to claim 24, wherein said colloid is a semiconductor material.

31. The apparatus according to claim 24, wherein said colloid is a material that is capable of producing an attractive van der Waals interaction with one of each other and the substrate.

32. The apparatus according to claim 24, wherein the substrate is a coverslip.

33. The apparatus according to claim 24, wherein said suspension includes colloidal particles from two or more colloidal species.

34. The apparatus according to claim 24, wherein only a portion of said colloidal particles are aggregated based upon a material and dimensional characteristics of said colloidal particles.

35. The apparatus according to claim 24, wherein said multi-dimensional structures are multiple colloidal particles.

36. The apparatus according to claim 24, wherein said multi-dimensional colloidal structure is an array, and said array is formed by combining said particles into a two-dimensional square lattice pattern.

37. The apparatus according to claim 36, wherein a three-dimensional crystal is formed from a plurality of arrays.

38. The apparatus according to claim 37, wherein said crystal is rotated relative to the substrate to achieve a desired orientation before depositing said crystal on said substrate.

39. The apparatus according to claim 36, wherein said multi-dimensional structure comprises:
an initial layer of particles deposited on said substrate as said lattice pattern by reducing a focal length of a collection of the optical traps until all of the particles in said initial layer are in contact with said substrate.

40. The apparatus according to claim 39, wherein said multi-dimensional structure comprises:
a second layer of additional individual particles positioned within said lattice pattern to form.

41. The apparatus according to claim 40, wherein the particles in said initial layer and in said second layer are of different sizes.

42. The apparatus according to claim 24, wherein said multi-dimensional structure is removed from said electrolyte solution without critical point drying.

43. The apparatus according to claim 24, wherein said multi-dimensional structure is a photonic bandgap crystal.

44. An apparatus for assembling a multi-colloidal structure comprising:
a holographic optical tweezers which forms optical traps;
a sample cell including:
a substrate;
a sample chamber disposed on said substrate;
an input tube into said sample chamber;
an output tube from said sample chamber;
a stable suspension of charge-stabilized colloidal particles; and
a pH adjusted solution introduced to said sample chamber, adjusted to one of an acidic and basic level depending on a charge species of said colloidal particles;
wherein said particles are trapped by said holographic optical tweezers to form a multi-dimensional structure.

45. The apparatus according to claim 44, further comprising:
a syringe through which said electrolyte is pumped by a syringe pump.

46. The apparatus according to claim 45, wherein said syringe pump is used to control a flow rate of said electrolyte into said sample chamber.

47. The apparatus according to claim 44, wherein said colloid is a monodisperse substance.

48. The apparatus according to claim 44, wherein said colloid is a biological material.

49. The apparatus according to claim 44, wherein said biological material is one of a cell and a vesicle.

50. The apparatus according to claim 44, wherein said colloid is a semiconductor material.

51. The apparatus according to claim 44, wherein said colloid is a material that is capable of producing an attractive van der Waals interaction with one of each other and the substrate.

52. The apparatus according to claim 44, wherein the substrate is a coverslip.

53. The apparatus according to claim 44, wherein said suspension includes colloidal particles from two or more colloidal species.

54. The apparatus according to claim 44, wherein only a portion of said colloidal particles are aggregated based upon a material and dimensional characteristics of said colloidal particles.

55. The apparatus according to claim 44, wherein said multi-dimensional structures are multiple colloidal particles.

56. The apparatus according to claim 44, wherein groups of particles are brought into contact with said substrate by adjusting a focal length of entire groups of trapped particles.

57. The apparatus according to claim 44, wherein said multi-dimensional colloidal structure is an array, and said array is formed by combining said particles into a two-dimensional square lattice pattern.

58. The apparatus according to claim 57, wherein a three-dimensional crystal is formed from a plurality of arrays, and is suspended above said substrate.

59. The apparatus according to claim 58, wherein said crystal is rotated relative to the substrate to achieve a desired orientation before depositing said crystal on said substrate.

60. The apparatus according to claim 57, wherein said multi-dimensional structure comprises:
an initial layer of particles deposited on said substrate as said lattice pattern by reducing a focal length of a collection of the optical traps until all of the particles in said initial layer are in contact with said substrate.

61. The apparatus according to claim 60, wherein said multi-dimensional structure comprises:
a second layer of additional individual particles positioned within said lattice pattern to form.

62. The apparatus according to claim 61, wherein the particles in said initial layer and in said second layer are of different sizes.

63. The apparatus according to claim 44, wherein said multi-dimensional structure is removed from said electrolyte solution without critical point drying.

64. The apparatus according to claim 44, wherein said multi-dimensional structure is a photonic bandgap crystal.

65. An apparatus for assembling a multi-colloidal structure comprising:
a holographic optical tweezers which forms optical traps;
a sample cell including:
a substrate;
a sample chamber disposed on said substrate;
an input tube into said sample chamber;
an output tube from said sample chamber;
a stable suspension of charge-stabilized colloidal particles;
an electrolyte introduced into said sample chamber via said input tube; and
a pH adjusted solution introduced into said sample chamber, adjusted to one of an acidic and basic level depending on a charge species of said colloidal particles;
wherein said particles are trapped by said holographic optical tweezers to form a multi-dimensional structure.
